(19) United States
(12) Patent Application Publication
(10) Pub. No.: US 2019/0212977 A1
(43) Pub. Date: Jul. 11, 2019

(54) CANDIDATE GEOGRAPHIC COORDINATE RANKING

(71) Applicant: Facebook, Inc., Menlo Park, CA (US)

(72) Inventors: Robert James Sicurelli, III, Manhattan, NY (US); Jan Kalis, New York, NY (US); Eugenio Robert Fortanely, New York, NY (US); Jan Kodovsky, Rochester, NY (US); Aaron Bryan Adcock, New York, NY (US)

(21) Appl. No.: 15/864,206

(22) Filed: Jan. 8, 2018

(51) Int. Cl. G06F 7/08; G06N 99/00; G06N 7/00; G06F 17/30

(52) U.S. Cl. CPC G06F 7/08; G06F 17/30241; G06N 7/00; G06N 99/005

(57) ABSTRACT

In one embodiment, a method includes accessing a number of candidate geographic coordinates that each correspond to a place. At least one of the candidate geographic coordinates is determined based on a polygon extracted from a satellite image that corresponds to an area circumscribing the place and each of the candidate geographic coordinates is associated with one or more features. The method also includes, for each of the candidate geographic coordinates, determining a confidence score by applying to the signals associated with the candidate geographic coordinate a function trained by a machine-learning (ML) algorithm; ranking the candidate geographic coordinates based on their confidence scores; and assigning to the place a highest ranked one of the candidate geographic coordinates as the place's geo-location.

### TECHNICAL FIELD

This disclosure generally relates to location determination.

### BACKGROUND

A social-networking system, which may include a social-networking website, may enable its users (such as persons or organizations) to interact with it and with each other through it. The social-networking system may, with input from a user, create and store in the social-networking system a user profile associated with the user. The user profile may include demographic information, communication-channel information, and information on personal interests of the user. The social-networking system may also, with input from a user, create and store a record of relationships of the user with other users of the social-networking system, as well as provide services (e.g., wall posts, photo-sharing, event organization, messaging, games, or advertisements) to facilitate social interaction between or among users.

The social-networking system may send over one or more networks content or messages related to its services to a mobile or other computing device of a user. A user may also install software applications on a mobile or other computing device of the user for accessing a user profile of the user and other data within the social-networking system. The social-networking system may generate a personalized set of content objects to display to a user, such as a newsfeed of aggregated stories of other users connected to the user.

A mobile computing device—such as a smartphone, tablet computer, or laptop computer—may include functionality for determining its location, direction, or orientation, such as a GPS receiver, compass, gyroscope, or accelerometer. Such a device may also include functionality for wireless communication, such as BLUETOOTH communication, near-field communication (NFC), or infrared (IR) communication or communication with a wireless local area networks (WLANs) or cellular-telephone network. Such a device may also include one or more cameras, scanners, touchscreens, microphones, or speakers. Mobile computing devices may also execute software applications, such as games, web browsers, or social-networking applications. With social-networking applications, users may connect, communicate, and share information with other users in their social networks.

### SUMMARY OF PARTICULAR EMBODIMENTS

Particular embodiments may determine a highest-ranked geographic coordinates associated with a place from a set of candidate geographic coordinates. An example use of the candidate geographic coordinates is “pins” that are used to visually indicate the location of the place on a mapping application. Candidate geographic coordinates may be inferred based on a number of methods. As an example and not by way of limitation, methods include extraction of polygons in satellite images, clustering of anonymized location data (e.g., from check-ins), geographic coordinates of a center of the place (e.g., city center), or geocoding of the place address. In particular embodiments, a machine learning (ML) model is applied to the set of candidate geographic coordinates. The output of the ML model is a confidence score for the candidate geographic coordinates. In particular embodiments, the highest ranked candidate geographic coordinates is assigned to the place.

In particular embodiments, one or more candidate geographic coordinates may be determined through extraction of polygons from satellite images of the place. As an example and not by way of limitation, polygons may be extracted from satellite images through the use of line segment detection. One or more candidate geographic coordinates of the polygons may be derived. Another method of obtaining candidate geographic coordinates is through clustering of anonymized check-in data. In particular embodiments, a clustering algorithm may be applied to anonymized location data obtained using global positioning system (GPS) data logged over a pre-determined period of time (e.g., 90 days). The clustering algorithm groups the anonymized check-in data into one or more clusters and the candidate geographic coordinates may be the centroid of the clusters.

In particular embodiments, the ML model or decision tree is trained using a training set of candidate geographic coordinates. For example, the training set of curated candidate geographic coordinates and a corresponding result of whether the highest ranked geographic coordinates corresponds to the curated geographic coordinates for the place. For example, a positive result if the highest-ranked geographic coordinates are within a pre-determined distance (e.g., 160 meters) from the curated geographic coordinates for the place. The ML model used to rank the candidate geographic coordinates may take into account a number of features associated with the various sources of candidate geographic coordinates.

The embodiments disclosed herein are only examples, and the scope of this disclosure is not limited to them. Particular embodiments may include all, some, or none of the components, elements, features, functions, operations, or steps of the embodiments disclosed above. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1 illustrates an example polygon with example map tiles and sample points.

FIGS. 2A-2C illustrate an example clustering of location data.

FIG. 3 illustrates an example method for determining a ranking of candidate geographic coordinates.

FIG. 4 illustrates an example network environment associated with a social-networking system.

FIG. 5 illustrates an example computer system.

### DESCRIPTION OF EXAMPLE EMBODIMENTS

In particular embodiments, a place may have an associated with a “place” page. As an example and not by way of limitation, the “place” page may include information associated with the place, such as for example a map, reviews, location information, hours, etc. Particular embodiments may determine a highest-ranked geographic coordinates associated with a place from a set of candidate geographic coordinates. In particular embodiments, a place, described below, may have an assigned geo-location. Herein, geo-location may refer to a set of geographic coordinates (e.g., latitude-longitude pair). An example use of the candidate geographic coordinates is “pins” that are used to visually indicate the location of the place on a mapping application. Candidate geographic coordinates may be inferred based on a number of methods. As an example and not by way of limitation, methods include extraction of polygons in map tiles from satellite images, clustering of anonymized location data (e.g., from check-ins), geographic coordinates of a center of the place (e.g., city center), or geocoding of the place address. In particular embodiments, a machine learning (ML) model is applied to the set of candidate geographic coordinates. The output of the ML model may be a confidence score for the candidate geographic coordinates.

In particular embodiments, one or more candidate geographic coordinates may be determined through extraction of polygons from map tiles (e.g., satellite images) of the place. As an example and not by way of limitation, polygons may be extracted from satellite images through the use of line segment detection. One or more candidate geographic coordinates of the polygons may be derived, as described below. Another method of obtaining candidate geographic coordinates is through clustering of anonymized check-in data. In particular embodiments, a clustering algorithm (e.g., DBSCAN, k-means, or HDBSCAN) may be applied to anonymized location data obtained using global positioning system (GPS) data logged over a pre-determined period of time (e.g., 90 days). The clustering algorithm groups the anonymized check-in data into one or more clusters and the candidate geographic coordinates may be the centroid of the clusters.

In particular embodiments, the ML model or decision tree is trained using a training set of candidate geographic coordinates or geo-locations. For example, the training set of curated candidate geographic coordinates and a corresponding result of whether the highest ranked geographic coordinates corresponds to the curated geographic coordinates for the place. For example, a positive result if the highest-ranked geographic coordinates are within a pre-determined distance (e.g., 160 meters) from the curated geographic coordinates for the place. The ML model used to rank the candidate geographic coordinates may take into account a number of features associated with the various sources of candidate geographic coordinates. In particular embodiments, the highest ranked candidate geographic coordinates is assigned to the place. As an example and not by way of limitation, the highest-ranked geographic coordinate may be the assigned as the geo-location of the place on the “place” page.

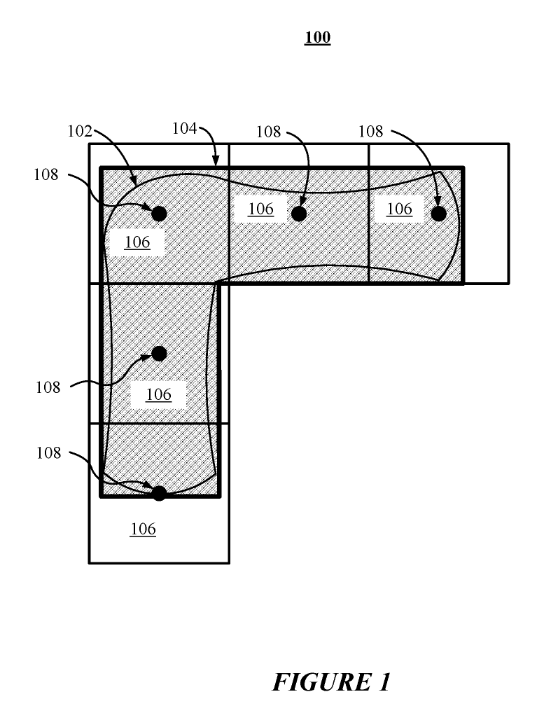

FIG. 1 illustrates an example polygon with map tiles and sample points. A map may be divided into map tiles (hereinafter also “tiles”) 106, where each tile 106 represents a particular geographic area of the map. Particular locations or places may be located within particular tiles of a map. As an example and not by way of limitation, a location X may be within a first tile, and locations Y and Z may be within a second tile. In particular embodiments, a tile may include one or more objects or places having a location within the tile. Where tiles 106 represent a particular geographic area, an object or place 102 having a location within that geographic area may be considered to be within tiles 106. Herein, a place may refer to a large area or structure or a combination of one or more large areas or one or more structures. As examples and not by way of limitation, place 102 may include an airport, park, shopping mall, corporate campus, college campus, stadium, museum, neighborhood, city, movie theater, restaurant, landmark, or any other suitable place or combination of suitable places. In particular embodiments, place 102 may have a size or dimension on the order of approximately 10 meters, 100 meters, 1 kilometer, 10 kilometers, or any other suitable dimension.

In particular embodiments, place 102 may be associated with a particular map tiles 106 if all or part of place 102 is located within the particular map tiles 106. In particular embodiments, place 102 may be associated with a particular map tile if at least part of place 102 is located within a pre-determined threshold distance of the particular map tile 106. In particular embodiments, multiple parts of a particular place 102 may be located within multiple tiles, and place 102 may be associated each of with these multiple tiles 106. In particular embodiments, a particular tile may contain all or part of multiple places, and the particular tile may be associated with each of these multiple places. As an example and not by way of limitation, a particular tile may represent a particular geographic area that includes all or part of a restaurant, museum, and college campus, and the particular tile may be associated with each of these places. In particular embodiments, place 102 may be associated with one or more tiles, and a tile may be associated with one or more places. Although this disclosure describes and illustrates particular places associated with particular tiles, this disclosure contemplates any suitable places associated with any suitable tiles.

In particular embodiments, place 102 may be modeled as a polygon 104 that closely surrounds or forms a boundary around place 102. In particular embodiments, one or more lines that make up circumscribing polygon 104 may touch, overlap, or intersect one or more lines or vertices that form an outer boundary of place 102. A bounding box may be constructed around polygon 104, and a N×N grid of sample points 108 superimposed over the bounding box, where N is any suitable positive integer (e.g., 10, 20, 30, etc.). In particular embodiments, sample points located outside polygon 104 may be discarded, and sample points 108 located within or on the border of polygon 104 may be kept. The remaining sample points 108 may be associated with the place, and each sample point may be associated with a particular map tile. Although this disclosure describes and illustrates particular places and particular polygons that circumscribe particular places, this disclosure contemplates any suitable places and any suitable polygons that circumscribe any suitable places.

In particular embodiments, polygon 104 may be determined by analyzing satellite images of the area surrounding or circumscribing place 102. As an example and not by way of limitation, a polygon corresponding to a stadium may be extracted through line segment detection of a satellite image of the map tile containing the area circumscribing the place. In the example of FIG. 1, each map tile 106 has an associated sample point 108 located at the center of map tile 106. In particular embodiments, some map tiles 106 may be fully contained within polygon 104 and some map tiles 106 may be partially contained within polygon 104. In particular embodiments, a group of map tiles 106 may collectively define an area that circumscribes place 102 or polygon 104 representing place 102. In particular embodiments, place 102 may be associated with each map tile of a group of map tiles that circumscribe the place. Although this disclosure describes and illustrates polygon 104 covered by map tiles 106 having particular sample points 108, this disclosure contemplates any suitable polygons covered by any suitable map tiles having any suitable sample points.

Place 102 may include one or more geographic coordinates (e.g., latitude-longitude pairs), where each geographic coordinate corresponds to sample point 108 associated with place 102. Particular embodiments model places 102 as polygons 104, where each place 102 may then associated with multiple sample points 108 rather than a single sample point 108. In particular embodiments, each sample point 108 may be a candidate geographic coordinate for place 102.

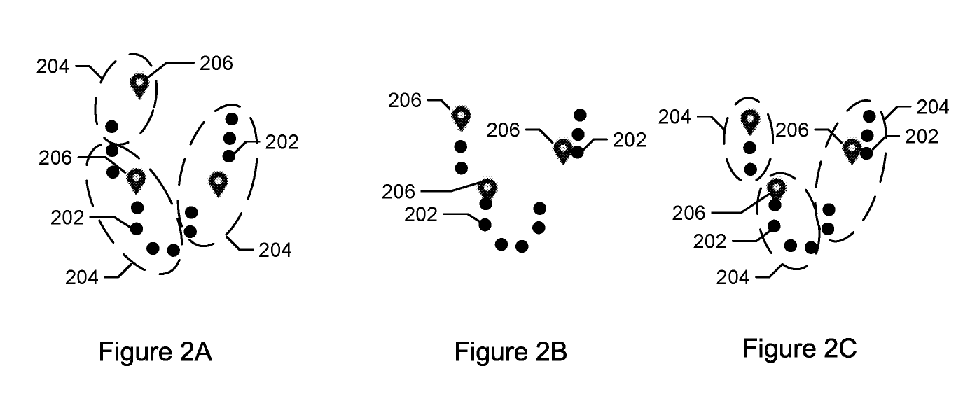

FIGS. 2A-2C illustrate an example clustering of location data. In particular embodiments, a user may “check-in” to place 102 (e.g., a landmark or business) through the location services of a client system. As an example and not by way of limitation, a “check-in” at a particular place may occur when a user is physically located at a place and, using a mobile device, access a social-networking system to register the user's presence at the place. A user of a mobile device may access a “check-in” function that searches for candidate places that are within a pre-determined distance from the current location of the user. For example, a user's location may be determined to be in Las Vegas (either from GPS, cellular triangulation, check-in, or being checked in by another user). As an example and not by way of limitation, a client application of a computing device may access Global Positioning System (GPS) or other geo-location functions supported by the computing device and report the user's current location (e.g., on a social networking system). For example, a record of the user's check-in activity may be stored in a database.

In particular embodiments, location-data points 202 from multiple users (e.g., associated with anonymized “check-in” data or from automatic location polling) may be grouped to determine a cluster 204 that is representative of the multiple location-data points 202. The location-data points may grouped using a clustering algorithm, as described below. A spatial-clustering algorithm (e.g., density-based spatial clustering of applications with noise (DBSCAN)) may represent multiple geo-location data points as one or more geographic clusters. The DBSCAN algorithm groups together location-data points 202 that are closely packed together (points with many nearby neighbors) and marking as outliers location-data points that lie alone in low-density regions (whose nearest neighbors are too far away).

In particular embodiments, multiple location-data points 202 obtained through “check-ins” within a pre-determined distance of a particular geo-location obtained during a pre-determined period of time, such as for example 90 days, are clustered using a spatial-clustering algorithm. The spatial-clustering algorithm (e.g., DBSCAN or k-means) may represent location-data points 202 as one or more location clusters 204. In particular embodiments, for a distance-based clustering algorithm (e.g., k-means), centroids 206 of a pre-determined number of location clusters 204 may be substantially randomly distributed among geo-location data points 202, as illustrated in FIG. 2A. Location data points 202 may be assigned to a particular cluster 204 based at least in part on a distance between location data points 202 and each centroid 206. As an example and not by way of limitation, each location data point 202 may be assigned to a particular cluster 204 that has the minimum distance between the respective centroid 206 and respective location data point 202. In particular embodiments, for each cluster 204, a centroid 206 of all the location-data points 202 within each cluster 204 may be calculated and the location of centroid 206 updated to the location of the center of location-data points 202 of each cluster 204, as illustrated in the example of FIG. 2B.

As illustrated in the example of FIG. 2C, clusters 204 may be reformed by assigning each location data point 202 to a particular cluster 204 with the closest centroid 206. In particular embodiments, each centroid 206 may be a candidate geographic coordinate for place 102. The steps of calculating the centroid 206 of clusters 204, updating the location of centroids 206 to the centroid of location-data points 202 within each cluster 204, and reforming clusters 204 as illustrated in FIGS. 2A-C, may be performed a pre-determined number of times. Although this disclosure describes a grouping multiple geo-location data points using particular methods of spatial clustering, this disclosure contemplates grouping multiple location data points using any suitable method, such as for example clustering through DBSCAN, hierarchical DBSCAN (HDBSCAN), or k-means, or using kernel density estimation (KDE).

Other sources for candidate geographic coordinates may include geographic coordinates of a center of place 102 (e.g., city center), or geocoding of the address of place 102. Geocoding is the process of converting an address of place 102 to geographic coordinates. In particular embodiments, the geographic coordinates that result from geocoding the address of place 102 may be used as a candidate geographic coordinate for place 102. In particular embodiments, a user or entity (e.g., manager or owner) responsible for place 102 may provide a geographic coordinate for place 102 that may be used as a candidate geographic coordinate for place 102. Although this disclosure describes deriving candidate geographic coordinates using particular sources (e.g., clustering location data or geocoding), this disclosure contemplates deriving using any suitable method, such as for example the location of a city center.

As described above, a ML-trained model or function may be applied to the set of candidate geographic coordinates. In particular embodiments, a confidence score for each candidate geographic coordinate of place 102 is calculated using the ML-trained model applied to one or more features, described below, associated with each candidate geographic coordinate. The ML algorithm may access the features of the candidate geographic coordinates. In particular embodiments, the ML algorithm (e.g., gradient-boosted decision tree) may optimize a predictor function or computer model. As an example and not by way of limitation, gradient boosting is a ML technique that may be used to model classification problems that produces a prediction model in the form of an ensemble of prediction models (e.g., decision trees). In many supervised learning problems, there is an output variable and a vector of input variables connected by a joint probability distribution. Using a training set of known values of the input (features) and corresponding values of the output (answer), the goal is to find a predictor function that minimizes the expected value of the difference between the function and the output variable. In particular embodiments, calculating the confidence score may be performed using a prediction model or function constructed using a set of training data that includes a feature vector associated with the candidate geographic coordinates of place 102 and a corresponding answer (e.g., curated geographic coordinates of place 102). In particular embodiments, a feature vector may map values of features associated with a pre-determined number (e.g., 3000) of candidate geographic coordinates, described below, to an n-dimensional feature vector and answer may be manually curated geographic coordinates of corresponding places 102. As an example and not by way of limitation, the ML algorithm may calculate the confidence score for the candidate geographic coordinates based on features or signals of the respective candidate geographic coordinates. The learned association of the machine-learning algorithm may be used to optimize a set of weights of the predictive model or function to achieve a maximum number of positive results. As an example and not by way of limitation, a positive result may be based on whether the candidate geographic coordinates are within a pre-determined distance (e.g., 160 meters) from the corresponding manually curated geographic coordinates. In the case of polygons, a positive result from the ML-trained model is when the highest ranked candidate geographic coordinates is located within polygon the polygon corresponding to place 102 and a negative result highest ranked candidate geographic coordinates is located without the polygon. Each of the candidate geographic coordinates may have one or more features or signals. In particular embodiments, the features of the candidate geographic coordinates are based on the source from which the respective candidate geographic coordinates are derived. As an example and not by way of limitation, for candidate geographic coordinates derived from polygons a feature is a distance from candidate geographic coordinate to a polygon representative of the place. Example features for candidate geographic coordinates derived from clustering anonymized location data may include a distance of the respective candidate geographic coordinates to a distance to a largest cluster (or 2nd largest, 3rd largest, etc., or top 5 largest combined by number of location data points of cluster 204), the number of location data points represented by the respective cluster, distribution of the location data associated with place 102 (e.g., the number of location data points of the respective cluster 204 falls within the top 20th percentile of the total number of location data points of place 102, top 80th percentile, or the ratio of the location data points), life span (e.g., amount of time between oldest to newest location data point of cluster 204), noise properties (e.g., amount of noise in the location data), convex hull or the area of the respective cluster 204, or the percentile of the number of location data point represented by the candidate geographic coordinates. Examples of other features may include a time difference between a time the candidate geographic coordinates is being ranked and an average time of the location data associated with place 102 or whether the candidate geographic coordinates is within the bounding box of a city polygon.

Example features for candidate geographic coordinates derived from geo-coded addresses may include a distance from the candidate geographic coordinates to the respective geo-coded address, whether the geo-coded address maps to a “point” address (instead of larger area), a distance from the candidate geographic coordinates to a city geographic coordinates, or whether the candidate geographic coordinates is derived from a geo-coded address that is house type, postal code, town, country, or city. Although this disclosure describes particular candidate geographic coordinating having particular features or signals, this disclosure contemplates any suitable candidate geographic coordinates having any suitable features or signals.

In particular embodiments, the machine-learning model or predictor function may include one or more weights or coefficients that are associated with each feature. The model or predictor function may be used the training data to determine a set of value for the weights of the model that best matches the answers or answer vector of the training data. In particular embodiments, the predictor function is periodically retrained based on updated candidate geographic coordinates that may be derived from any suitable method. The candidate geographic coordinates for each place 102 may be ranked based on the confidence score that is the output of the ML model. The highest ranked candidate geographic coordinates of place 102 may be assigned to place 102. As an example and not by way of limitation, the highest ranked candidate geographic coordinates of place 102 may be used to represent the location of place 102 on a respective “place” page. As another example, the highest ranked candidate geographic coordinates may be used to represent the location of place 102 on a mapping application.

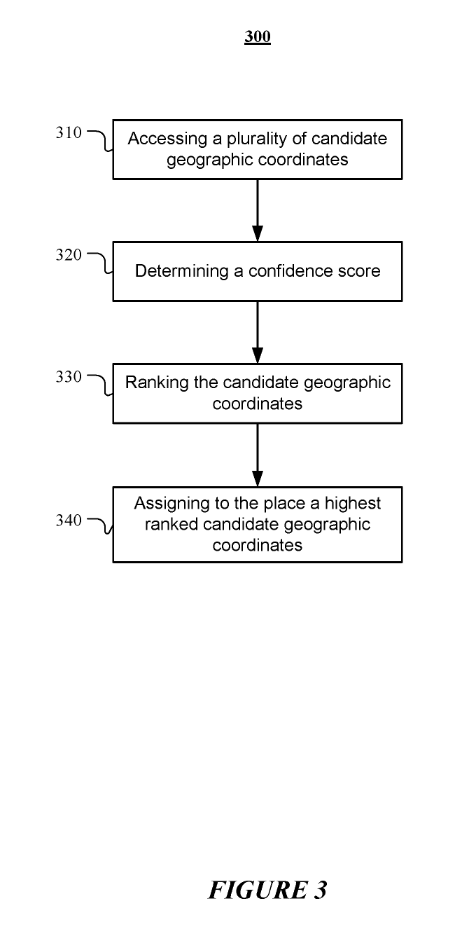

FIG. 3 illustrates an example method for determining a ranking of candidate geographic coordinates. The method 300 may begin at step 310, where a number of candidate geographic coordinates that each correspond to a place are accessed. In particular embodiments, at least one of the candidate geographic coordinates is determined based on a polygon that corresponds to an area circumscribing the place. Each of the candidate geographic coordinates may be associated with one or more features. At step 320, for each of the candidate geographic coordinates, a confidence score is determined by applying to the signals associated with the candidate geographic coordinate, a function trained by a ML algorithm. At step 330, the candidate geographic coordinates are ranking based on their confidence scores. At step 340, a highest ranked one of the candidate geographic coordinates as the place's geo-location assigned to the place. Particular embodiments may repeat one or more steps of the method of FIG. 3, where appropriate. Although this disclosure describes and illustrates particular steps of the method of FIG. 3 as occurring in a particular order, this disclosure contemplates any suitable steps of the method of FIG. 3 occurring in any suitable order. Moreover, although this disclosure describes and illustrates an example method for determining a ranking of candidate geographic coordinates including the particular steps of the method of FIG. 3, this disclosure contemplates any suitable method for determining a ranking of candidate geographic coordinates including any suitable steps, which may include all, some, or none of the steps of the method of FIG. 3, where appropriate. Furthermore, although this disclosure describes and illustrates particular components, devices, or systems carrying out particular steps of the method of FIG. 3, this disclosure contemplates any suitable combination of any suitable components, devices, or systems carrying out any suitable steps of the method of FIG. 3.

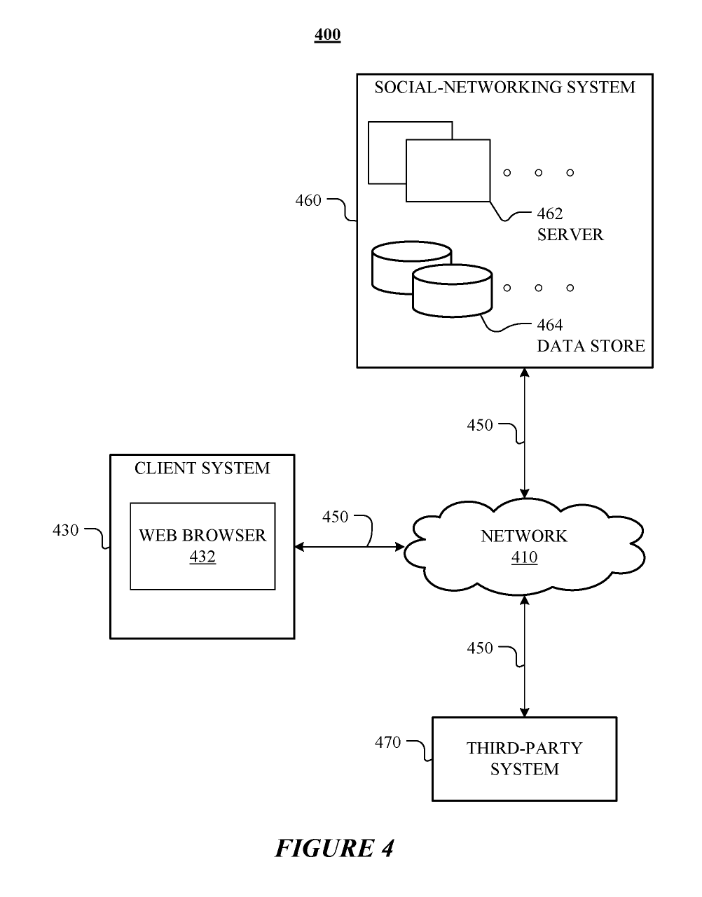

FIG. 4 illustrates an example network environment associated with a social-networking system. Network environment 400 includes a client system 430, a social-networking system 460, and a third-party system 470 connected to each other by a network 410. Although FIG. 4 illustrates a particular arrangement of client system 430, social-networking system 460, third-party system 470, and network 410, this disclosure contemplates any suitable arrangement of client system 430, social-networking system 460, third-party system 470, and network 410. As an example and not by way of limitation, two or more of client system 430, social-networking system 460, and third-party system 470 may be connected to each other directly, bypassing network 410. As another example, two or more of client system 430, social-networking system 460, and third-party system 470 may be physically or logically co-located with each other in whole or in part. Moreover, although FIG. 4 illustrates a particular number of client systems 430, social-networking systems 460, third-party systems 470, and networks 410, this disclosure contemplates any suitable number of client systems 430, social-networking systems 460, third-party systems 470, and networks 410. As an example and not by way of limitation, network environment 400 may include multiple client system 430, social-networking systems 460, third-party systems 470, and networks 410.

This disclosure contemplates any suitable network 410. As an example and not by way of limitation, one or more portions of network 410 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 410 may include one or more networks 410.

Links 450 may connect client system 430, social-networking system 460, and third-party system 470 to communication network 410 or to each other. This disclosure contemplates any suitable links 450. In particular embodiments, one or more links 450 include one or more wireline (such as for example Digital Subscriber Line (DSL) or Data Over Cable Service Interface Specification (DOC SIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 450 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 450, or a combination of two or more such links 450. Links 450 need not necessarily be the same throughout network environment 400. One or more first links 450 may differ in one or more respects from one or more second links 450.

In particular embodiments, client system 430 may be an electronic device including hardware, software, or embedded logic components or a combination of two or more such components and capable of carrying out the appropriate functionalities implemented or supported by client system 430. As an example and not by way of limitation, a client system 430 may include a computer system such as a desktop computer, notebook or laptop computer, netbook, a tablet computer, e-book reader, GPS device, camera, personal digital assistant (PDA), handheld electronic device, cellular telephone, smartphone, augmented/virtual reality device, other suitable electronic device, or any suitable combination thereof. This disclosure contemplates any suitable client systems 430. A client system 430 may enable a network user at client system 430 to access network 410. A client system 430 may enable its user to communicate with other users at other client systems 430.

In particular embodiments, client system 430 may include a web browser 432, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at client system 430 may enter a Uniform Resource Locator (URL) or other address directing the web browser 432 to a particular server (such as server 162, or a server associated with a third-party system 470), and the web browser 432 may generate a Hyper Text Transfer Protocol (HTTP) request and communicate the HTTP request to server. The server may accept the HTTP request and communicate to client system 430 one or more Hyper Text Markup Language (HTML) files responsive to the HTTP request. Client system 430 may render a webpage based on the HTML files from the server for presentation to the user. This disclosure contemplates any suitable webpage files. As an example and not by way of limitation, webpages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, social-networking system 460 may be a network-addressable computing system that can host an online social network. Social-networking system 460 may generate, store, receive, and send social-networking data, such as, for example, user-profile data, concept-profile data, social-graph information, or other suitable data related to the online social network. Social-networking system 460 may be accessed by the other components of network environment 400 either directly or via network 410. As an example and not by way of limitation, client system 430 may access social-networking system 460 using a web browser 432, or a native application associated with social-networking system 460 (e.g., a mobile social-networking application, a messaging application, another suitable application, or any combination thereof) either directly or via network 410. In particular embodiments, social-networking system 460 may include one or more servers 462. Each server 462 may be a unitary server or a distributed server spanning multiple computers or multiple datacenters. Servers 462 may be of various types, such as, for example and without limitation, web server, news server, mail server, message server, advertising server, file server, application server, exchange server, database server, proxy server, another server suitable for performing functions or processes described herein, or any combination thereof. In particular embodiments, each server 462 may include hardware, software, or embedded logic components or a combination of two or more such components for carrying out the appropriate functionalities implemented or supported by server 462. In particular embodiments, social-networking system 460 may include one or more data stores 464. Data stores 464 may be used to store various types of information. In particular embodiments, the information stored in data stores 464 may be organized according to specific data structures. In particular embodiments, each data store 464 may be a relational, columnar, correlation, or other suitable database. Although this disclosure describes or illustrates particular types of databases, this disclosure contemplates any suitable types of databases. Particular embodiments may provide interfaces that enable a client system 430, a social-networking system 460, or a third-party system 470 to manage, retrieve, modify, add, or delete, the information stored in data store 464.

In particular embodiments, social-networking system 460 may store one or more social graphs in one or more data stores 464. In particular embodiments, a social graph may include multiple nodes—which may include multiple user nodes (each corresponding to a particular user) or multiple concept nodes (each corresponding to a particular concept)—and multiple edges connecting the nodes. Social-networking system 460 may provide users of the online social network the ability to communicate and interact with other users. In particular embodiments, users may join the online social network via social-networking system 460 and then add connections (e.g., relationships) to a number of other users of social-networking system 460 to whom they want to be connected. Herein, the term “friend” may refer to any other user of social-networking system 460 with whom a user has formed a connection, association, or relationship via social-networking system 460.

In particular embodiments, social-networking system 460 may provide users with the ability to take actions on various types of items or objects, supported by social-networking system 460. As an example and not by way of limitation, the items and objects may include groups or social networks to which users of social-networking system 460 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in social-networking system 460 or by an external system of third-party system 470, which is separate from social-networking system 460 and coupled to social-networking system 460 via a network 410.

In particular embodiments, social-networking system 460 may be capable of linking a variety of entities. As an example and not by way of limitation, social-networking system 460 may enable users to interact with each other as well as receive content from third-party systems 470 or other entities, or to allow users to interact with these entities through an application programming interfaces (API) or other communication channels.

In particular embodiments, a third-party system 470 may include one or more types of servers, one or more data stores, one or more interfaces, including but not limited to APIs, one or more web services, one or more content sources, one or more networks, or any other suitable components, e.g., that servers may communicate with. A third-party system 470 may be operated by a different entity from an entity operating social-networking system 460. In particular embodiments, however, social-networking system 460 and third-party systems 470 may operate in conjunction with each other to provide social-networking services to users of social-networking system 460 or third-party systems 470. In this sense, social-networking system 460 may provide a platform, or backbone, which other systems, such as third-party systems 470, may use to provide social-networking services and functionality to users across the Internet.

In particular embodiments, a third-party system 470 may include a third-party content object provider. A third-party content object provider may include one or more sources of content objects, which may be communicated to a client system 430. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, social-networking system 460 also includes user-generated content objects, which may enhance a user's interactions with social-networking system 460. User-generated content may include anything a user can add, upload, send, or “post” to social-networking system 460. As an example and not by way of limitation, a user communicates posts to social-networking system 460 from a client system 430. Posts may include data such as status updates or other textual data, location information, photos, videos, links, music or other similar data or media. Content may also be added to social-networking system 460 by a third-party through a “communication channel,” such as a newsfeed or stream.

In particular embodiments, social-networking system 460 may include a variety of servers, sub-systems, programs, modules, logs, and data stores. In particular embodiments, social-networking system 460 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. Social-networking system 460 may also include suitable components such as network interfaces, security mechanisms, load balancers, failover servers, management-and-network-operations consoles, other suitable components, or any suitable combination thereof. In particular embodiments, social-networking system 460 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking social-networking system 460 to one or more client systems 430 or one or more third-party system 470 via network 410. The web server may include a mail server or other messaging functionality for receiving and routing messages between social-networking system 460 and one or more client systems 430. An API-request server may allow a third-party system 470 to access information from social-networking system 460 by calling one or more APIs. An action logger may be used to receive communications from a web server about a user's actions on or off social-networking system 460. In conjunction with the action log, a third-party-content-object log may be maintained of user exposures to third-party-content objects. A notification controller may provide information regarding content objects to a client system 430. Information may be pushed to a client system 430 as notifications, or information may be pulled from client system 430 responsive to a request received from client system 430. Authorization servers may be used to enforce one or more privacy settings of the users of social-networking system 460. A privacy setting of a user determines how particular information associated with a user can be shared. The authorization server may allow users to opt in to or opt out of having their actions logged by social-networking system 460 or shared with other systems (e.g., third-party system 470), such as, for example, by setting appropriate privacy settings. Third-party-content-object stores may be used to store content objects received from third parties, such as a third-party system 470. Location stores may be used for storing location information received from client systems 430 associated with users. Advertisement-pricing modules may combine social information, the current time, location information, or other suitable information to provide relevant advertisements, in the form of notifications, to a user.

In particular embodiments, one or more of the content objects of the online social network may be associated with a privacy setting. The privacy settings (or “access settings”) for an object may be stored in any suitable manner, such as, for example, in association with the object, in an index on an authorization server, in another suitable manner, or any combination thereof. A privacy setting of an object may specify how the object (or particular information associated with an object) can be accessed (e.g., viewed or shared) using the online social network. Where the privacy settings for an object allow a particular user to access that object, the object may be described as being “visible” with respect to that user. As an example and not by way of limitation, a user of the online social network may specify privacy settings for a user-profile page that identify a set of users that may access the work experience information on the user-profile page, thus excluding other users from accessing the information. In particular embodiments, the privacy settings may specify a “blocked list” of users that should not be allowed to access certain information associated with the object. In other words, the blocked list may specify one or more users or entities for which an object is not visible. As an example and not by way of limitation, a user may specify a set of users that may not access photos albums associated with the user, thus excluding those users from accessing the photo albums (while also possibly allowing certain users not within the set of users to access the photo albums). In particular embodiments, privacy settings may be associated with particular social-graph elements. Privacy settings of a social-graph element, such as a node or an edge, may specify how the social-graph element, information associated with the social-graph element, or content objects associated with the social-graph element can be accessed using the online social network. As an example and not by way of limitation, a particular concept node corresponding to a particular photo may have a privacy setting specifying that the photo may only be accessed by users tagged in the photo and their friends. In particular embodiments, privacy settings may allow users to opt in or opt out of having their actions logged by social-networking system 460 or shared with other systems (e.g., third-party system 470). In particular embodiments, the privacy settings associated with an object may specify any suitable granularity of permitted access or denial of access. As an example and not by way of limitation, access or denial of access may be specified for particular users (e.g., only me, my roommates, and my boss), users within a particular degrees-of-separation (e.g., friends, or friends-of-friends), user groups (e.g., the gaming club, my family), user networks (e.g., employees of particular employers, students or alumni of particular university), all users (“public”), no users (“private”), users of third-party systems 470, particular applications (e.g., third-party applications, external websites), other suitable users or entities, or any combination thereof. Although this disclosure describes using particular privacy settings in a particular manner, this disclosure contemplates using any suitable privacy settings in any suitable manner.

In particular embodiments, one or more servers 462 may be authorization/privacy servers for enforcing privacy settings. In response to a request from a user (or other entity) for a particular object stored in a data store 464, social-networking system 460 may send a request to the data store 464 for the object. The request may identify the user associated with the request and may only be sent to the user (or a client system 430 of the user) if the authorization server determines that the user is authorized to access the object based on the privacy settings associated with the object. If the requesting user is not authorized to access the object, the authorization server may prevent the requested object from being retrieved from the data store 464, or may prevent the requested object from being sent to the user. In the search query context, an object may only be generated as a search result if the querying user is authorized to access the object. In other words, the object must have a visibility that is visible to the querying user. If the object has a visibility that is not visible to the user, the object may be excluded from the search results. Although this disclosure describes enforcing privacy settings in a particular manner, this disclosure contemplates enforcing privacy settings in any suitable manner.

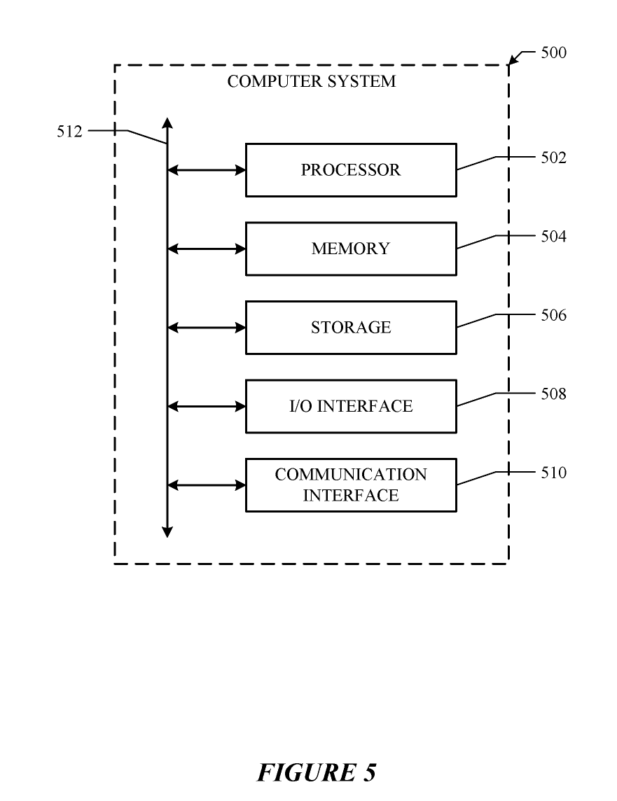

FIG. 5 illustrates an example computer system. In particular embodiments, one or more computer systems 500 perform one or more steps of one or more methods described or illustrated herein. In particular embodiments, one or more computer systems 500 provide functionality described or illustrated herein. In particular embodiments, software running on one or more computer systems 500 performs one or more steps of one or more methods described or illustrated herein or provides functionality described or illustrated herein. Particular embodiments include one or more portions of one or more computer systems 500. Herein, reference to a computer system may encompass a computing device, and vice versa, where appropriate. Moreover, reference to a computer system may encompass one or more computer systems, where appropriate.

This disclosure contemplates any suitable number of computer systems 500. This disclosure contemplates computer system 500 taking any suitable physical form. As example and not by way of limitation, computer system 500 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 500 may include one or more computer systems 500; be unitary or distributed; span multiple locations; span multiple machines; span multiple data centers; or reside in a cloud, which may include one or more cloud components in one or more networks. Where appropriate, one or more computer systems 500 may perform without substantial spatial or temporal limitation one or more steps of one or more methods described or illustrated herein. As an example and not by way of limitation, one or more computer systems 500 may perform in real time or in batch mode one or more steps of one or more methods described or illustrated herein. One or more computer systems 500 may perform at different times or at different locations one or more steps of one or more methods described or illustrated herein, where appropriate.

In particular embodiments, computer system 500 includes a processor 502, memory 504, storage 506, an input/output (I/O) interface 508, a communication interface 510, and a bus 512. Although this disclosure describes and illustrates a particular computer system having a particular number of particular components in a particular arrangement, this disclosure contemplates any suitable computer system having any suitable number of any suitable components in any suitable arrangement.

In particular embodiments, processor 502 includes hardware for executing instructions, such as those making up a computer program. As an example and not by way of limitation, to execute instructions, processor 502 may retrieve (or fetch) the instructions from an internal register, an internal cache, memory 504, or storage 506; decode and execute them; and then write one or more results to an internal register, an internal cache, memory 504, or storage 506. In particular embodiments, processor 502 may include one or more internal caches for data, instructions, or addresses. This disclosure contemplates processor 502 including any suitable number of any suitable internal caches, where appropriate. As an example and not by way of limitation, processor 502 may include one or more instruction caches, one or more data caches, and one or more translation lookaside buffers (TLBs). Instructions in the instruction caches may be copies of instructions in memory 504 or storage 506, and the instruction caches may speed up retrieval of those instructions by processor 502. Data in the data caches may be copies of data in memory 504 or storage 506 for instructions executing at processor 502 to operate on; the results of previous instructions executed at processor 502 for access by subsequent instructions executing at processor 502 or for writing to memory 504 or storage 506; or other suitable data. The data caches may speed up read or write operations by processor 502. The TLBs may speed up virtual-address translation for processor 502. In particular embodiments, processor 502 may include one or more internal registers for data, instructions, or addresses. This disclosure contemplates processor 502 including any suitable number of any suitable internal registers, where appropriate. Where appropriate, processor 502 may include one or more arithmetic logic units (ALUs); be a multi-core processor; or include one or more processors 502. Although this disclosure describes and illustrates a particular processor, this disclosure contemplates any suitable processor.

In particular embodiments, memory 504 includes main memory for storing instructions for processor 502 to execute or data for processor 502 to operate on. As an example and not by way of limitation, computer system 500 may load instructions from storage 506 or another source (such as, for example, another computer system 500) to memory 504. Processor 502 may then load the instructions from memory 504 to an internal register or internal cache. To execute the instructions, processor 502 may retrieve the instructions from the internal register or internal cache and decode them. During or after execution of the instructions, processor 502 may write one or more results (which may be intermediate or final results) to the internal register or internal cache. Processor 502 may then write one or more of those results to memory 504. In particular embodiments, processor 502 executes only instructions in one or more internal registers or internal caches or in memory 504 (as opposed to storage 506 or elsewhere) and operates only on data in one or more internal registers or internal caches or in memory 504 (as opposed to storage 506 or elsewhere). One or more memory buses (which may each include an address bus and a data bus) may couple processor 502 to memory 504. Bus 512 may include one or more memory buses, as described below. In particular embodiments, one or more memory management units (MMUs) reside between processor 502 and memory 504 and facilitate accesses to memory 504 requested by processor 502. In particular embodiments, memory 504 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 504 may include one or more memories 504, where appropriate. Although this disclosure describes and illustrates particular memory, this disclosure contemplates any suitable memory.

In particular embodiments, storage 506 includes mass storage for data or instructions. As an example and not by way of limitation, storage 506 may include a hard disk drive (HDD), a floppy disk drive, flash memory, an optical disc, a magneto-optical disc, magnetic tape, or a Universal Serial Bus (USB) drive or a combination of two or more of these. Storage 506 may include removable or non-removable (or fixed) media, where appropriate. Storage 506 may be internal or external to computer system 500, where appropriate. In particular embodiments, storage 506 is non-volatile, solid-state memory. In particular embodiments, storage 506 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 506 taking any suitable physical form. Storage 506 may include one or more storage control units facilitating communication between processor 502 and storage 506, where appropriate. Where appropriate, storage 506 may include one or more storages 506. Although this disclosure describes and illustrates particular storage, this disclosure contemplates any suitable storage.

In particular embodiments, I/O interface 508 includes hardware, software, or both, providing one or more interfaces for communication between computer system 500 and one or more I/O devices. Computer system 500 may include one or more of these I/O devices, where appropriate. One or more of these I/O devices may enable communication between a person and computer system 500. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 508 for them. Where appropriate, I/O interface 508 may include one or more device or software drivers enabling processor 502 to drive one or more of these I/O devices. I/O interface 508 may include one or more I/O interfaces 508, where appropriate. Although this disclosure describes and illustrates a particular I/O interface, this disclosure contemplates any suitable I/O interface.

In particular embodiments, communication interface 510 includes hardware, software, or both providing one or more interfaces for communication (such as, for example, packet-based communication) between computer system 500 and one or more other computer systems 500 or one or more networks. As an example and not by way of limitation, communication interface 510 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 510 for it. As an example and not by way of limitation, computer system 500 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 500 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 500 may include any suitable communication interface 510 for any of these networks, where appropriate. Communication interface 510 may include one or more communication interfaces 510, where appropriate. Although this disclosure describes and illustrates a particular communication interface, this disclosure contemplates any suitable communication interface.

In particular embodiments, bus 512 includes hardware, software, or both coupling components of computer system 500 to each other. As an example and not by way of limitation, bus 512 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 512 may include one or more buses 512, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising, by one or more computing devices:
accessing a plurality of candidate geographic coordinates that each correspond to a place, wherein:
at least one of the candidate geographic coordinates is determined based on a polygon that corresponds to an area circumscribing the place; and
each of the candidate geographic coordinates is associated with one or more features;
for each of the candidate geographic coordinates, determining a confidence score by applying to the signals associated with the candidate geographic coordinate a function trained by a machine-learning (ML) algorithm;
ranking the candidate geographic coordinates based on their confidence scores; and
assigning to the place a highest ranked one of the candidate geographic coordinates as the place's geo-location.

2. The method of claim 1, wherein the features comprise a distance from a respective candidate geographic coordinates to a polygon representative of the place, a distance of the respective candidate geographic coordinates to a distance to a largest cluster, a number of location data points represented by a respective cluster, a distribution of location data associated with the place, or a distance from the respective candidate geographic coordinates to a respective geo-coded address.

3. The method of claim 1, wherein one or more of the plurality of candidate geographic coordinates are derived based on clustering of location data associated with the particular geo-location, or geocoding of an address of the particular geo-location.

4. The method of claim 3, wherein:
the clustering of the location data is based on a k-means, density-based spatial clustering of applications with noise (DBSCAN), or hierarchical (HDBSCAN) algorithm; and
the location data comprises check-in data from users of a social-networking system.

5. The method of claim 1, further comprising retraining the function based on updated candidate geographic coordinates.

6. The method of claim 1, wherein:
the ML algorithm is a gradient boosted decision tree (GBDT); and
the ML algorithm is trained using location data from a known geo-location and with an associated answer vector.

7. The method of claim 1, wherein highest ranked candidate geographic coordinate corresponds to a pin that graphically indicates the place's geo-location on a mapping application.

8. One or more computer-readable non-transitory storage media embodying software that is operable when executed to:
access a plurality of candidate geographic coordinates that each correspond to a place, wherein:
at least one of the candidate geographic coordinates is determined based on a polygon that corresponds to an area circumscribing the place; and
each of the candidate geographic coordinates is associated with one or more features;
for each of the candidate geographic coordinates, determine a confidence score by applying to the signals associated with the candidate geographic coordinate a function trained by a machine-learning (ML) algorithm;
rank the candidate geographic coordinates based on their confidence scores; and
assign to the place a highest ranked one of the candidate geographic coordinates as the place's geo-location.

9. The media of claim 8, wherein the features comprise a distance from a respective candidate geographic coordinates to a polygon representative of the place, a distance of the respective candidate geographic coordinates to a distance to a largest cluster, a number of location data points represented by a respective cluster, a distribution of location data associated with the place, or a distance from the respective candidate geographic coordinates to a respective geo-coded address.

10. The media of claim 8, wherein one or more of the plurality of candidate geographic coordinates are derived based on clustering of location data associated with the particular geo-location, or geocoding of an address of the particular geo-location.

11. The media of claim 10, wherein:
the clustering of the location data is based on a k-means, density-based spatial clustering of applications with noise (DBSCAN), or hierarchical (HDBSCAN) algorithm; and
the location data comprises check-in data from users of a social-networking system.

12. The media of claim 8, wherein the software is further operable to retrain the function based on updated candidate geographic coordinates.

13. The media of claim 8, wherein:
the ML algorithm is a gradient boosted decision tree (GBDT); and
the ML algorithm is trained using location data from a known geo-location and with an associated answer vector.

14. The media of claim 8, wherein highest ranked candidate geographic coordinate corresponds to a pin that graphically indicates the place's geo-location on a mapping application.

15. A system comprising:
one or more processors; and
a memory coupled to the processors comprising instructions executable by the processors, the processors being operable when executing the instructions to:
access a plurality of candidate geographic coordinates that each correspond to a place, wherein:
at least one of the candidate geographic coordinates is determined based on a polygon that corresponds to an area circumscribing the place; and
each of the candidate geographic coordinates is associated with one or more features;
for each of the candidate geographic coordinates, determine a confidence score by applying to the signals associated with the candidate geographic coordinate a function trained by a machine-learning (ML) algorithm;
rank the candidate geographic coordinates based on their confidence scores; and
assign to the place a highest ranked one of the candidate geographic coordinates as the place's geo-location.

16. The system of claim 15, wherein the features comprise a distance from a respective candidate geographic coordinates to a polygon representative of the place, a distance of the respective candidate geographic coordinates to a distance to a largest cluster, a number of location data points represented by a respective cluster, a distribution of location data associated with the place, or a distance from the respective candidate geographic coordinates to a respective geo-coded address.

17. The system of claim 15, wherein one or more of the plurality of candidate geographic coordinates are derived based on clustering of location data associated with the particular geo-location, or geocoding of an address of the particular geo-location.

18. The system of claim 17, wherein:
the clustering of the location data is based on a k-means, density-based spatial clustering of applications with noise (DBSCAN), or hierarchical (HDBSCAN) algorithm; and
the location data comprises check-in data from users of a social-networking system.

19. The system of claim 15, wherein the processors are further operable to retrain the function based on updated candidate geographic coordinates.

20. The system of claim 15, wherein:
the ML algorithm is a gradient boosted decision tree (GBDT); and
the ML algorithm is trained using location data from a known geo-location and with an associated answer vector.
